(19) United States
(12) Patent Application Publication
(10) Pub. No.: US 2012/0026092 A1
(43) Pub. Date: Feb. 2, 2012

(54) TOUCH MOUSE OPERATION METHOD

(76) Inventors: Chih-Ming Tsao, Zhonghe City (TW); Ya-Ting Cheng, Zhonghe City (TW)

(21) Appl. No.: 13/169,247

(22) Filed: Jun. 27, 2011

(30) Foreign Application Priority Data
Jul. 30, 2010 (TW) 099125366

(51) Int. Cl. G06F 3/033

(52) U.S. Cl. 345/163

(57) ABSTRACT

Used in a touch mouse having housed in a touch mouse for transmitting a control signal to a computer for cursor control, the touch mouse having a touch-control circuit board bonded to the inner surface thereof, the touch-control circuit board comprising two deepest main notches and at least one sub-notch on the periphery thereof to provide multiple touch control induction zones. When a user touches the touch mouse to produce a touch signal, the location of the touch signal is calculated and then processed through a comparison procedure to determine whether or not the touch signal falls upon multiple touch control induction zones, and then it is to enter a first touch-control operation mode when positive, or to determined whether or not the touch signal falls upon one single touch control induction zone when negative. When the touch signal falls upon one single touch-control induction zone, it is to enter a second touch-control operation mode.

This application claims the priority benefit of Taiwan patent application number 099125366, filed on Jul. 30, 2011.

### BACKGROUND OF THE INVENTION

1. Field of the Invention

The present invention relates to touch mouse technology and more particularly, to a touch mouse operation method, which uses two properly cut circuit boards to constitute a touch-control circuit board that provides multiple touch control induction zones for quick touch control, enabling a user to operate the multiple touch control induction zones independently without causing interference.

2. Description of the Related Art

In computer systems, keyboard and mouse are the most popularly used input devices. Further, a mouse can be used to substitute for the directional keys of a keyboard for displacement track input. In a computer operating system, mouse has become a requisite peripheral apparatus. Many application software and instructions can be conveniently operated and executed through a mouse. The use of a mouse greatly facilitates the operation of a computer system.

Following fast development of electronic technology, mouse mechanism has been changed from the early key operating type to the modern touch control design. A conventional multi-button mouse cannot eliminate permeation of water or dust, and the lifespan of the mouse will be greatly shortened. Further, the buttons may fail due to elastic fatigue after a long use. A touch mouse eliminates the drawbacks of conventional multi-button mice. A user can touch the surface of a touch mouse to produce a control signal for controlling the cursor on the display screen of a computer.

A regular touch mouse generally comprises a touch-control circuit board attached to the inner surface of the housing of the mouse corresponding to the operation area on the outer wall of the housing of the mouse. However, under the concept of human-friendly design, the outer wall of the housing of a mouse may be curved for comfortable operation. In this case, the inner surface of the housing of the mouse will also be relatively curved. When bonding a planar touch-control circuit board to the curved inner surface of the housing of a touch mouse, the planar touch-control circuit board must be thin enough for covering the inner surface of the housing of the mouse positively and tightly without causing air pockets or bubbles. If the curvature of the inner surface of the housing is sharp, the thickness of the planar touch-control circuit board must be made thinner, complicating the fabrication and affecting the conductivity of the ITO (indium tin oxide). In consequence, the yield rate or touch-control stability will be affected.

Further, using a touch-control circuit board in a mouse for touch location detection needs to set coordinate values in the internal control circuit corresponding to different touch zones at the surface of the housing of the mouse. When the control circuit senses the presence of an object at the surface of the housing of the mouse, it determines the location of the object by means of comparing the sensed signal to the reference coordinate values stored therein. This comparison procedure requires a complicated computing operation. This computing operation is a big burden to the control circuit that does not have a strong computing function, and the touch control speed will be slowed down. Thus, the mouse will be unable to track the movement quickly and smoothly, and the sensing accuracy will be unstable

Therefore, it is desirable to provide a touch mouse that eliminates the aforesaid problems.

### SUMMARY OF THE INVENTION

The present invention has been accomplished under the circumstances in view. It is therefore the main object of the present invention to provide a touch mouse operation method, which eliminates the drawbacks of the conventional mouse devices.

To achieve this and other objects of the present invention, a touch mouse operation method is used in a touch mouse for enabling the touch mouse to be touched by a user to transmit a control signal to a computer for cursor control. The touch mouse comprises a touch-control circuit board having multiple notches for enabling the touch-control circuit board to provide multiple touch control induction zones for quick touch control operation. The multiple notches include two main notches and at least one sub-notch. Further, the cutting depth of the main notches is deeper than the at least one sub-notch. When a user touches the housing of the touch mouse with the hand corresponding to the touch-control circuit board, at least one touch signal will be produced, i.e., the touch sensor unit of the control module of the touch mouse senses the touch signals and transmits the sensed touch signals to the control unit of the control module in a proper order, enabling the control unit to calculate the location of each touch signal and then to determine whether or not the location of each touch signal falls upon multiple touch-control sensing zones or one single touch-control sensing zone. Thereafter, the control unit enters a first touch-control operation mode or a second touch-control operation mode subject to the determination result. By means of one single touch-control circuit board to provide multiple touch-control induction zones, the control unit rapidly calculates the touch location.

Further, after termination of a touch signal to be fallen upon multiple touch-control induction zones, the control unit will determine whether or not the sensed touch signal continuously or intermittently falls upon multiple touch control induction zones. If the sensed touch signal continuously falls upon multiple touch control induction zones, it enters the first touch-control operation mode. If the sensed touch signal intermittently falls upon multiple touch control induction zones, it enters the third touch-control operation mode.

Further, when the control unit receives a touch signal from the touch sensor unit, it compares the sensed touch signal to predetermined reference touch signals stored therein. When the sensed touch signal matches with one predetermined reference touch signal, the control unit determines whether or not the sensing of the touch signal surpasses a predetermined time period, and then denies the touch signal and does not transmit the signal to the computer when the sensing of the touch signal surpasses the predetermined time period. Thus, when a user rests the hand on the housing of the touch mouse, the touch mouse will not be triggered erroneously, assuring operation accuracy.

### BRIEF DESCRIPTION OF THE DRAWINGS

FIG. 1 is a flow chart of a touch mouse operation method in accordance with the present invention.

FIG. 2 is a schematic drawing illustrating a touch mouse used in a computer system in accordance with the present invention.

FIG. 3 is a schematic drawing illustrating the first circuit board and the second circuit board of the touch-control circuit board of the touch mouse in a separated status according to the present invention.

FIG. 4 is a schematic drawing illustrating the first circuit board and the second circuit board of the touch-control circuit board of the touch mouse joined together according to the present invention.

FIG. 5 is a block diagram of the control module of the touch mouse in accordance with the present invention.

FIG. 6 is a schematic drawing illustrating one operation example of the touch mouse in accordance with the present invention.

FIG. 7 is a schematic drawing illustrating another operation example of the touch mouse in accordance with the present invention.

FIG. 8 is a schematic drawing illustrating still another operation example of the touch mouse in accordance with the present invention.

FIG. 9 is a schematic drawing illustrating still another operation example of the touch mouse in accordance with the present invention.

FIG. 10 is a flow chart of an alternate form of the touch mouse operation method in accordance with the present invention.

### DETAILED DESCRIPTION OF THE PREFERRED EMBODIMENT

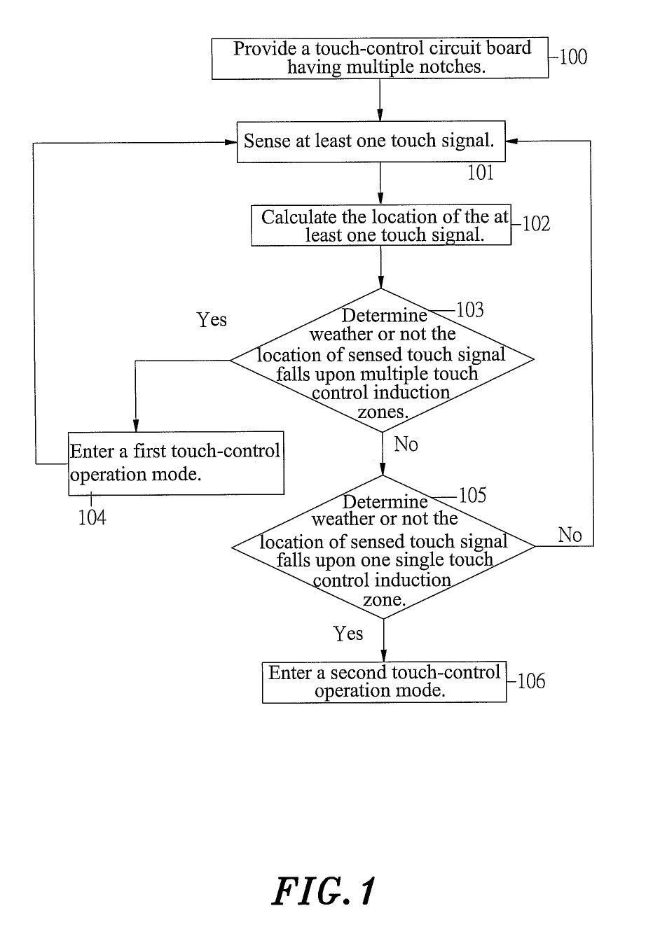

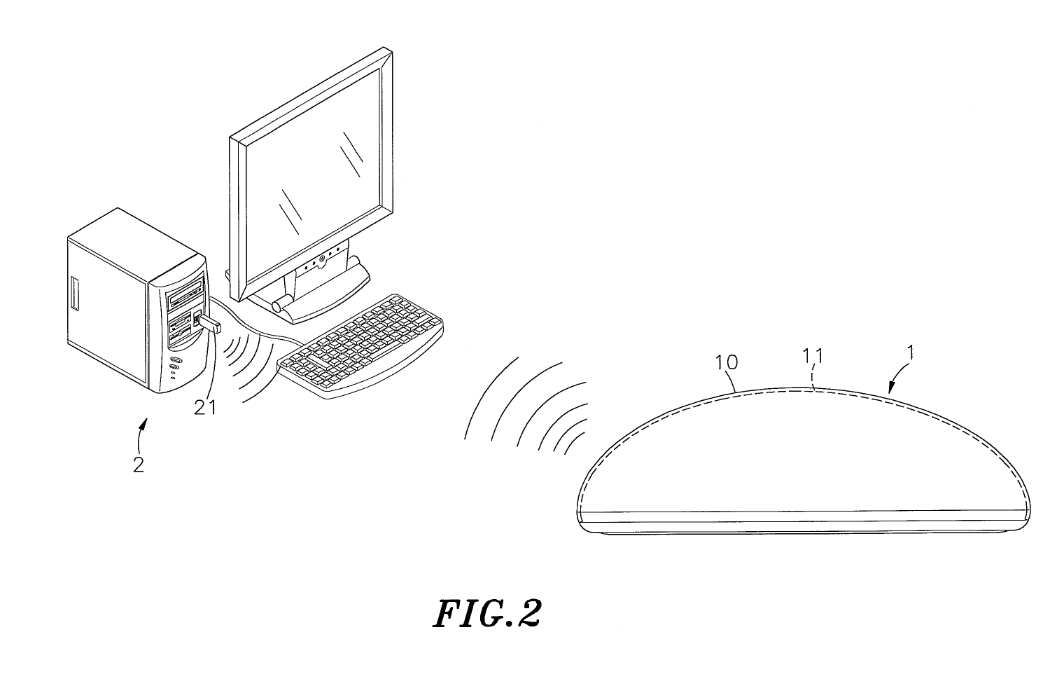

Referring to FIGS. 1 and 2, a touch mouse operation method in accordance with the present invention is used in a touch mouse 1 for controlling the touch mouse 1 to transmit touch signals to a computer 2 for cursor control. The touch mouse 1 comprises a touch-control circuit board 11 mounted on the inner surface of a housing 10 of the touch mouse 1 within the operating zone that is touchable by a user to run the operation. The touch control runs subject to the following steps:
(100) Provide the touch-control circuit board 11 having multiple notches for enabling the touch-control circuit board 11 to provide multiple touch control induction zones, wherein the multiple notches include two main notches that are deepest.
(101) Sense at least one touch signal.
(102) Calculate the location of the at least one touch signal.
(103) Determine weather or not the location of the sensed touch signal falls upon multiple touch control induction zones. And then proceed to step (104) when positive, or return to step (105) when negative.
(104) Enter a first touch-control operation mode, and then return to step (101).
(105) Determine weather or not the location of the sensed touch signal falls upon one single touch control induction zone? And then return to step (101) when negative, or proceed to step (106) when positive.
(106) Enter a second touch-control operation mode.

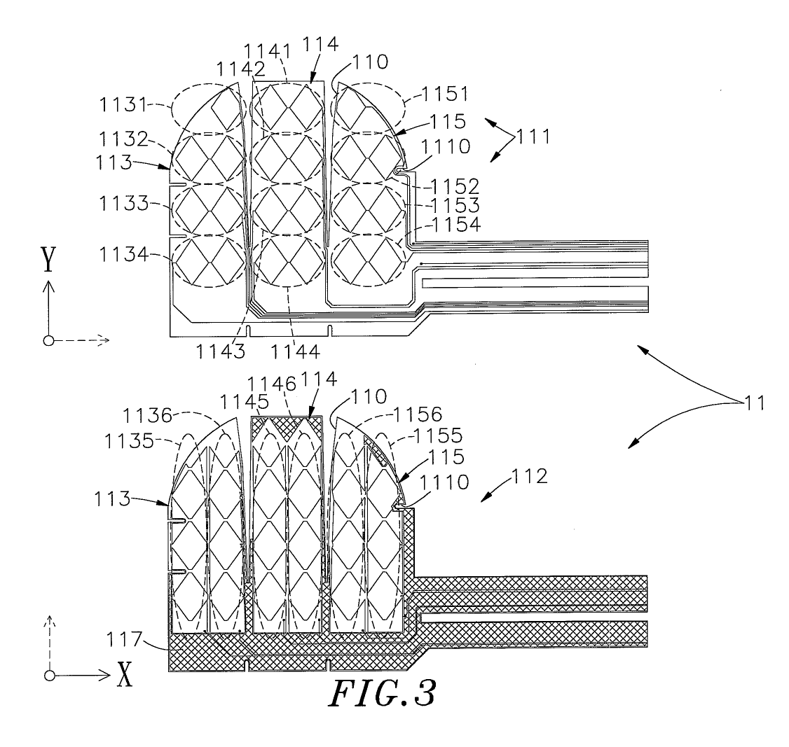

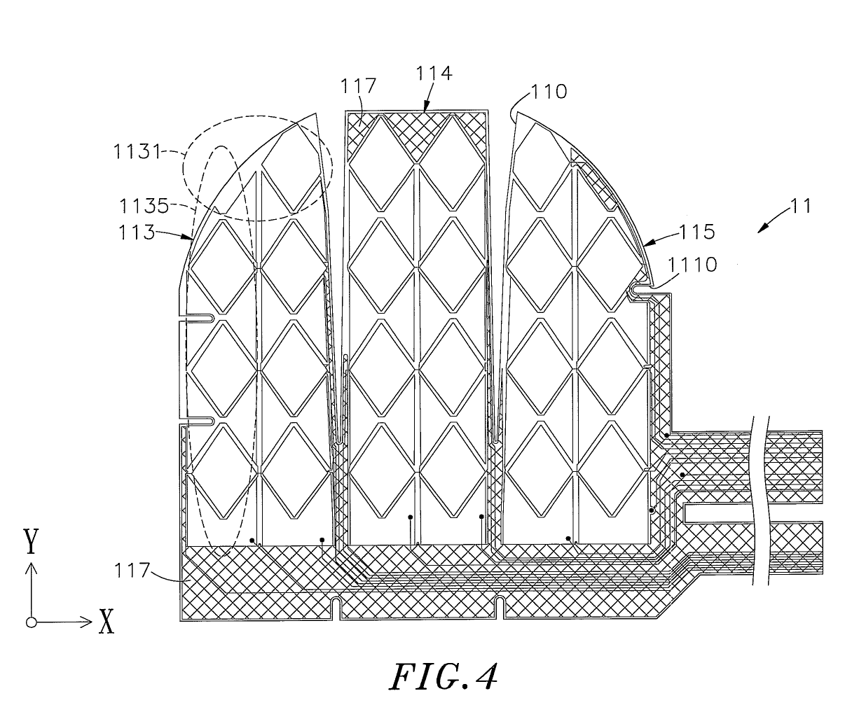

Referring to FIG. 3 and FIG. 4, the touch-control circuit board 11 in accordance with the present invention comprises a first circuit board 111 and a second circuit board 112. The first circuit board 111 and the second circuit board 112 are interconnected without overlap. The interconnection between the first circuit board 111 and the second circuit board 112 is of the known art and not within the scope of the present invention, therefore no further detailed description in this regard is necessary.

More particularly, the first circuit board 111 comprises a plurality of rhombic configuration circuit lines, forming a Y-axis (horizontal) touch control circuit; the second circuit board 112 comprises a plurality of hopper configuration circuit lines, forming an X-axis (vertical) touch control circuit. In other word, when the track position of multiple touch signals moves along the Y-axis, a Y-axis touch-control operation mode will be produced and, when the track position of multiple touch signals moves along the X-axis, an X-axis touch-control operation mode will be produced

Further, the first circuit board 111 and the second circuit board 112 each have multiple notches on the periphery. The locations and configurations of the notches on the first circuit board 111 correspond to that on the second circuit board 112. The notches of each of the first circuit board 111 and the second circuit board 112 include two main notches 110 and at least one sub-notch 1110. The cutting depth of the main notches 110 is deeper than the at least one sub-notch 1110. These two main notches 110 of each of the first circuit board 111 and the second circuit board 112 extend in Y-axis direction from the periphery of the first circuit board 111 or second circuit board 112 toward the inside thereof to evenly divide the touch control circuit into multiple parts, thereby enabling the touch-control circuit board 11 to provide multiple touch control induction zones, for example, a first touch control induction zone 113, a second touch control induction zone 114 and a third touch control induction zone 115, wherein the first touch control induction zone 113 acts as the mouse left button, the second touch control induction zone 114 acts as the mouse middle button and the third touch control induction zone 115 acts as the mouse right button. The circuit structure in each of the first touch control induction zone 113, second touch control induction zone 114 and third touch control induction zone 115 provides multiple touch points, for example, the first touch control induction zone 113 comprises 4 Y-axis touch points, namely, a first Y-axis touch point 1131, a second Y-axis touch point 1132, a third Y-axis touch point 1133 and a fourth Y-axis touch point 1134. In the same way, the second touch control induction zone 114 and the third touch control induction zone 115 each comprise the same number of Y-axis touch points, i.e., the second touch control induction zone 114 comprises a first Y-axis touch point 1141, a second Y-axis touch point 1142, a third Y-axis touch point 1143 and a fourth Y-axis touch point 1144; the third touch control induction zone 115 comprises a first Y-axis touch point 1151, a second Y-axis touch point 1152, a third Y-axis touch point 1153 and a fourth Y-axis touch point 1154.

On the other hand, the first touch control induction zone 113 further comprises 2 X-axis touch points, namely, the first X-axis touch point 1135 and the second X-axis touch point 1136.

In the same way, the second touch control induction zone 114 and the third touch control induction zone 115 each comprise the same number of X-axis touch points, i.e., the second touch control induction zone 114 comprises a first X-axis touch point 1145 and a second X-axis touch point 1146; the third touch control induction zone 115 comprises a first X-axis touch point 1155 and a second X-axis touch point 1156.

In this embodiment, every Y-axis touch point comprises one or two rhombic configuration circuit lines. The two rhombic configuration circuit lines in each Y-axis touch point are electrically interconnected. Further, each X-axis touch point comprises four hopper configuration circuit lines. The hopper configuration circuit lines in each X-axis touch point are electrically interconnected. Relatively, the circuit configurations of one Y-axis touch point or X-axis touch point are not interconnected with that of another Y-axis touch point or X-axis touch point. However, it is to be understood that the foresaid design of touch control induction zones, Y-axis touch points, X-axis touch points, rhombic configuration circuit lines or hopper configuration circuit lines in each Y-axis or X-axis touch point is simply an example of the present invention but not intended as limitations; the number of the touch control induction zones, Y-axis touch points, X-axis touch points, rhombic configuration circuit lines or hopper configuration circuit lines in each Y-axis or X-axis touch point can be changed without departing from the spirit and scope of the invention.

Further, the touch-control circuit board 11 comprises a low-impedance grounding circuit 117 extending around the multiple touch control induction zones for protection, ensuring touch control induction zone operation stability.

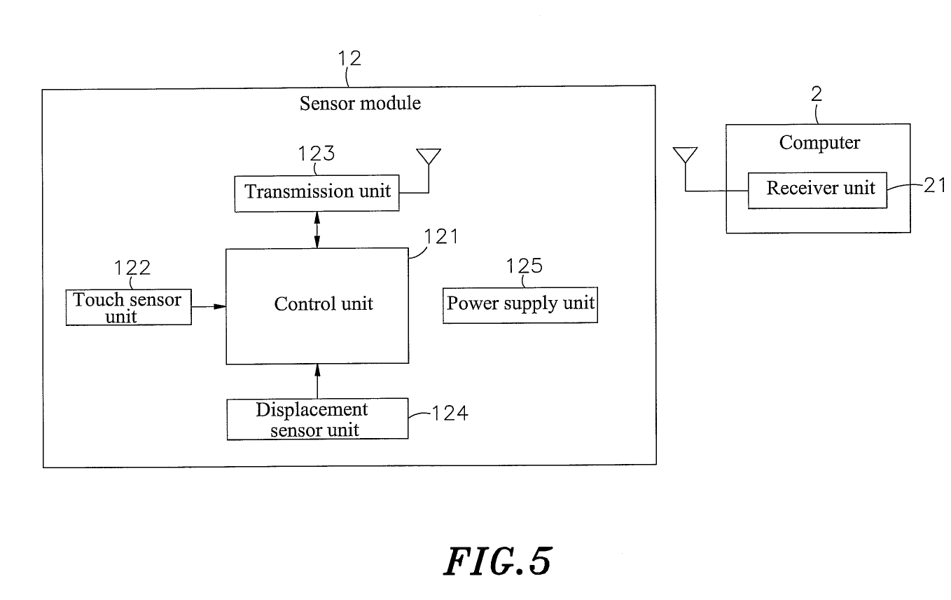

Referring also to FIG. 5, the touch mouse 1 further comprises a control module 12. The control module 12 comprises a control unit 121, a touch sensor unit 122, a transmission unit 123, a displacement sensor unit 124 and a power supply unit 125. The touch sensor unit 122, the transmission unit 123, the displacement sensor unit 124 and the power supply unit 125 are electrically connected to the control unit 121. By means of the transmission unit 123, the touch mouse 1 can transmit data or signal to a receiver unit 21 of a computer 2, or receive data or signal from the receiver unit 21 of the computer 2. When a user touched the surface of the housing 10 of the touch mouse 1 and touch sensor unit 122 sensed at least one touch signal, the touch sensor unit 122 immediately transmits each sensed touch signal to the control unit 121. Upon receipt of one touch signal, the control unit 121 calculates the location of the received touch signal, and determines weather or not the location of the touch signal falls upon multiple touch control induction zones. When positive, the control unit 121 controls the touch mouse 1 to enter a first touch-control operation mode. When negative, the control unit 121 further determines weather or not the location of the touch signal is within one single touch control induction zone. Then, the control unit 121 controls the touch mouse 1 to enter a second touch-control operation mode if the location of the sensed touch signal falls upon one single touch control induction zone and executes a next touch control operation flow cycle, or denies the control signal if the location of the sensed touch signal is not fall upon one single touch control induction zone. Further, the transmission unit 123 can be a wired or wireless transmission interface for intercommunication with the receiver unit 21 of the computer 2. Further the displacement sensor unit 124 can be an infrared sensor module, CMOS (complementary metal-oxide semiconductor) image sensor module or CCD (charge coupled device) image sensor module adapted to match with a LED or laser LED for measuring displacement of the housing 10 of the touch mouse 1 in X-axis and Y-axis. The light reflected by a target is focused on the sensor. The light quantity distribution of the entire beam spot entering the light receiving element is used to determine the beam spot center and identifies this as the target position. Subject to the functioning of the displacement sensor unit 124, the direction and amount of movement of the housing 10 are detected. As the structural details and sensing operation of the displacement sensor unit 124 are of the known art and not within the scope of the invention, no further detailed description in this regard is necessary.

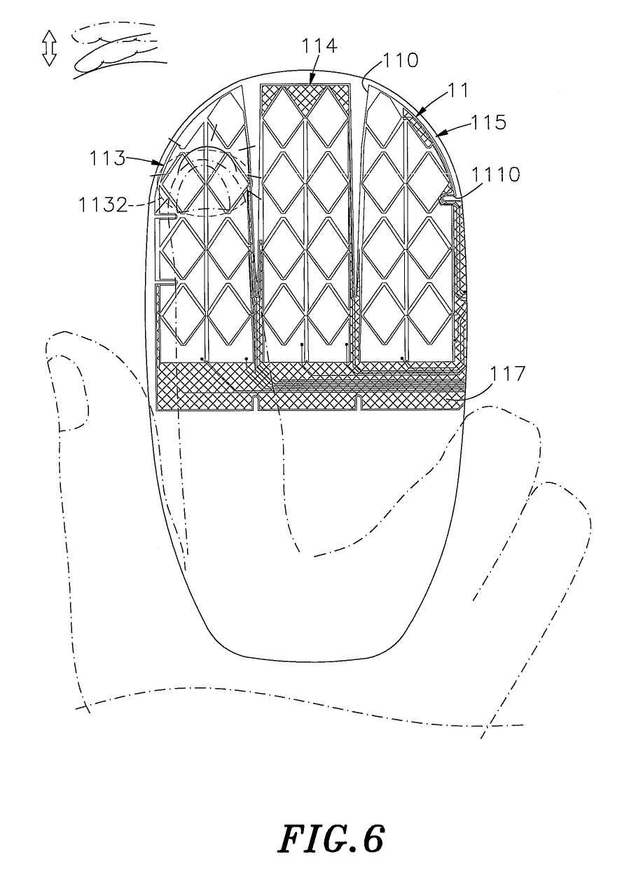

Referring to FIG. 6, when a user touched the operation area of the surface of the housing 10 of the touch mouse 1 corresponding to the location of the touch-control circuit board 11, the touch sensor unit 122 of the control module 12 senses the location of the user's finger and the touch control induction zone touched by the user's finger by means of the touch signal induced the touch-control circuit board 11. According to this example, the touch signal is a signal induced by one single touch point, for example, the second Y-axis touch point 1132 of the first touch control induction zone 113. The touch sensor unit 122 transmits this touch signal to the control unit 121. Thereafter, the control unit 121 determines whether or not the touch signal has been continuously received within a predetermined time interval. When negative, the control unit 121 executes calculation to obtain the touch location of the user's finger at the surface of the housing 10 of the touch mouse 1 and to generate a control signal, for example, mouse left button click signal, which control signal will then be transmitted by the touch mouse 1 to the computer 2 to click an iCON.

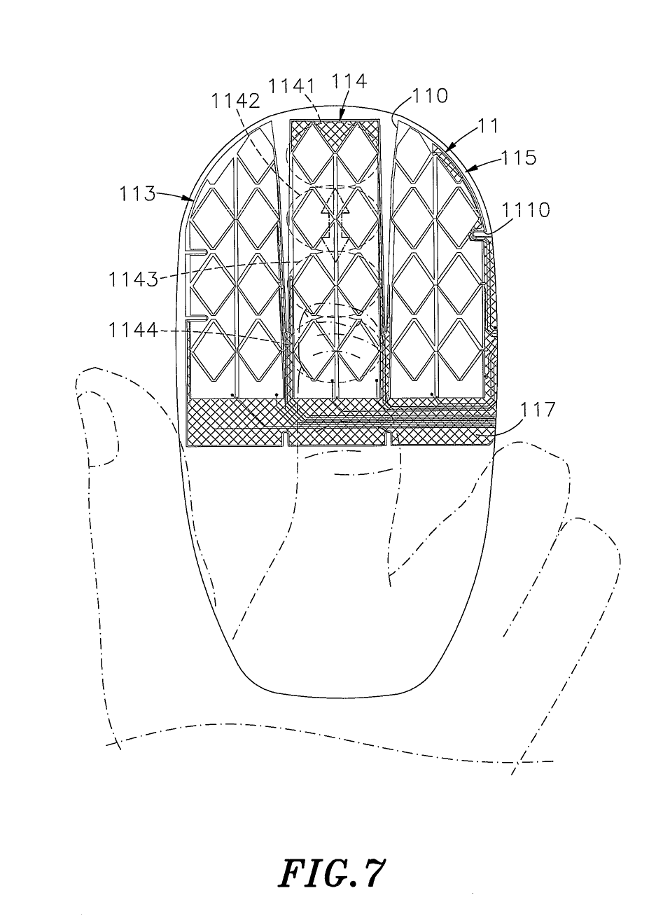

Referring to FIG. 7, when a user touched the operation area of the surface of the housing 10 of the touch mouse 1 corresponding to the location of the touch-control circuit board 11, the touch sensor unit 122 of the control module 12 senses the location of the user's finger and the touch control induction zone touched by the user's finger by means of the multiple touch signals induced the touch-control circuit board 11. According to this example, the touch signals are the signals induced by multiple touch points, for example, the first Y-axis touch point 1141, the second Y-axis touch point 1142, the third Y-axis touch point 1143 and the fourth Y-axis touch point 1144 of the second touch control induction zone 114. The touch sensor unit 122 transmits these touch signals to the control unit 121 in a proper order. Thereafter, the control unit 121 determines whether or not any other touch signal has been received within a predetermined time interval. When negative, the control unit 121 executes calculation to obtain the touch location of the user's finger at the surface of the housing 10 of the touch mouse 1 and to generate a control signal, for example, mouse middle button moving signal, which control signal will then be transmitted by the touch mouse 1 to the computer 2 to scroll up or down the displayed page. By means of calculating the touch sequence of the first Y-axis touch point and the last Y-axis touch point, the page up/down scrolling operation is determined.

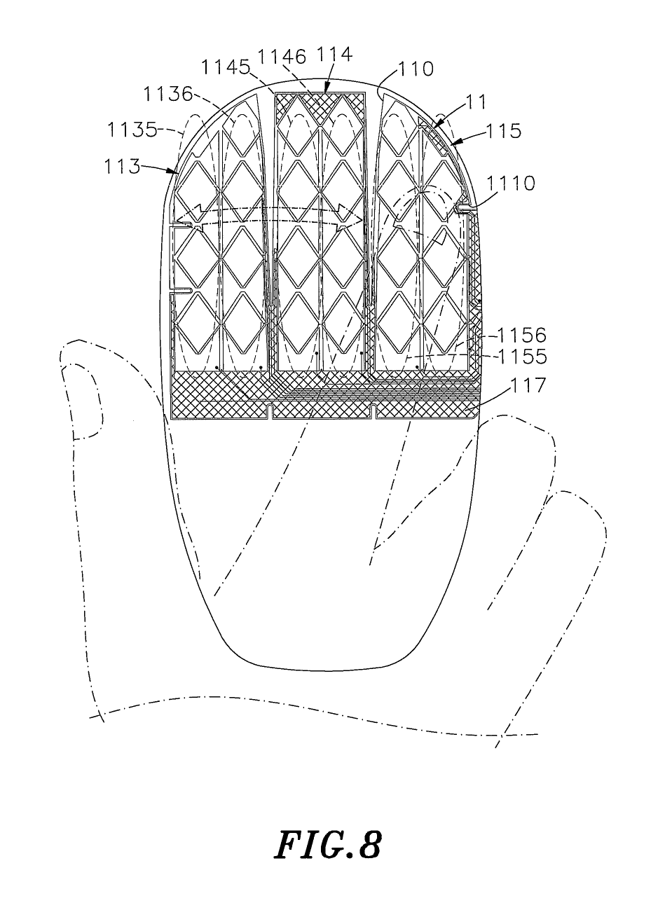

Referring to FIG. 8, when a user touched the operation area of the surface of the housing 10 of the touch mouse 1 corresponding to the location of the touch-control circuit board 11, the touch sensor unit 122 of the control module 12 senses the location of the user's finger and the touch control induction zone touched by the user's finger by means of the multiple touch signals induced the touch-control circuit board 11. According to this example, the touch signals are the signals induced by multiple touch points, for example, the first X-axis touch point 1135 and the second X-axis touch point 1136 of the first touch control induction zone 113, the first X-axis touch point 1145 and the second X-axis touch point 1146 of the second touch control induction zone 114 and the first X-axis touch point 1155 and the second X-axis touch point 1156 of the third touch control induction zone 115. The touch sensor unit 122 transmits these touch signals to the control unit 121 in a proper order. Thereafter, the control unit 121 determines whether or not the touch signals are continuously generated within a predetermined time interval. When negative, the control unit 121 executes calculation to obtain the touch location of the user's finger at the surface of the housing 10 of the touch mouse 1 and to generate a control signal, for example, page turning-over signal, which control signal will then be transmitted by the touch mouse 1 to the computer 2 to turn over the page. By means of calculating the touch sequence of the first X-axis touch point and the last X-axis touch point, the operation of turning over the page from the left side to the right side, or from the right side to the left side, is determined.

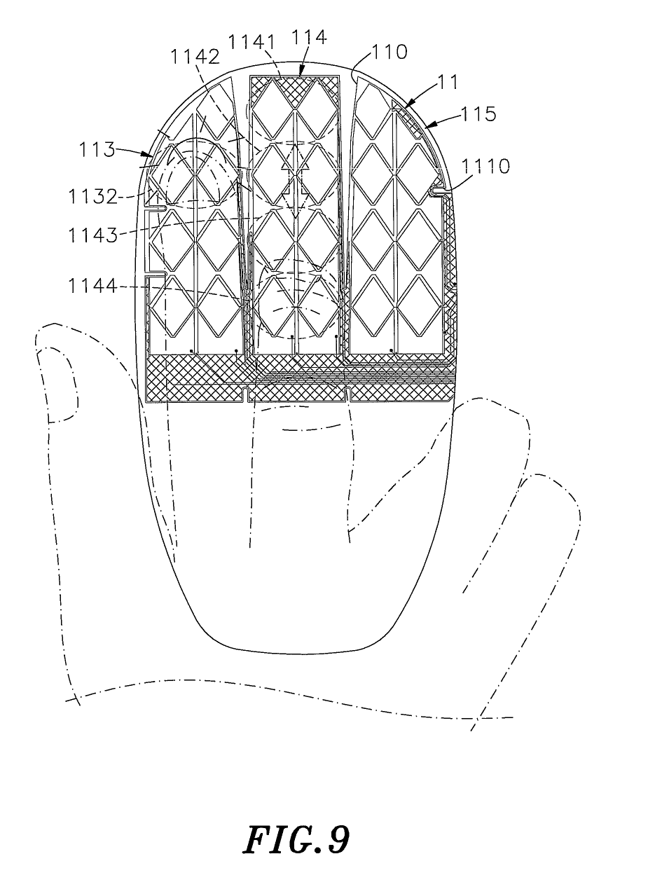

Referring to FIG. 9, when a user touched the operation area of the surface of the housing 10 of the touch mouse 1 corresponding to the location of the touch-control circuit board 11, the touch sensor unit 122 of the control module 12 senses the location of the user's finger and the touch control induction zone touched by the user's finger by means of the multiple touch signals induced the touch-control circuit board 11. According to this example, the touch signals are the signals induced by multiple touch points, for example, the second Y-axis touch point 1132 of the first touch control induction zone 113 and the first Y-axis touch point 1141, the second Y-axis touch point 1142, the third Y-axis touch point 1143 and the fourth Y-axis touch point 1144 of the second touch control induction zone 114. The touch sensor unit 122 transmits these touch signals to the control unit 121 in a proper order. Thereafter, the control unit 121 determines whether or not the touch signals are continuously generated within a predetermined time interval. When negative, the control unit 121 executes calculation to obtain the touch location of the user's finger at the surface of the housing 10 of the touch mouse 1 and to generate a control signal, for example, highlighting signal, which control signal will then be transmitted by the touch mouse 1 to the computer 2 to highlight character strings. By means of calculating the touch sequence of the first Y-axis touch point and the last Y-axis touch point in the second touch control induction zone 114, it is determined to start the highlighting operation from the bottom side toward the top side, or from the top side toward the bottom side. Subject to independent operation of the multiple touch control induction zones defined in the touch-control circuit board 11, multiple operation modes are provided.

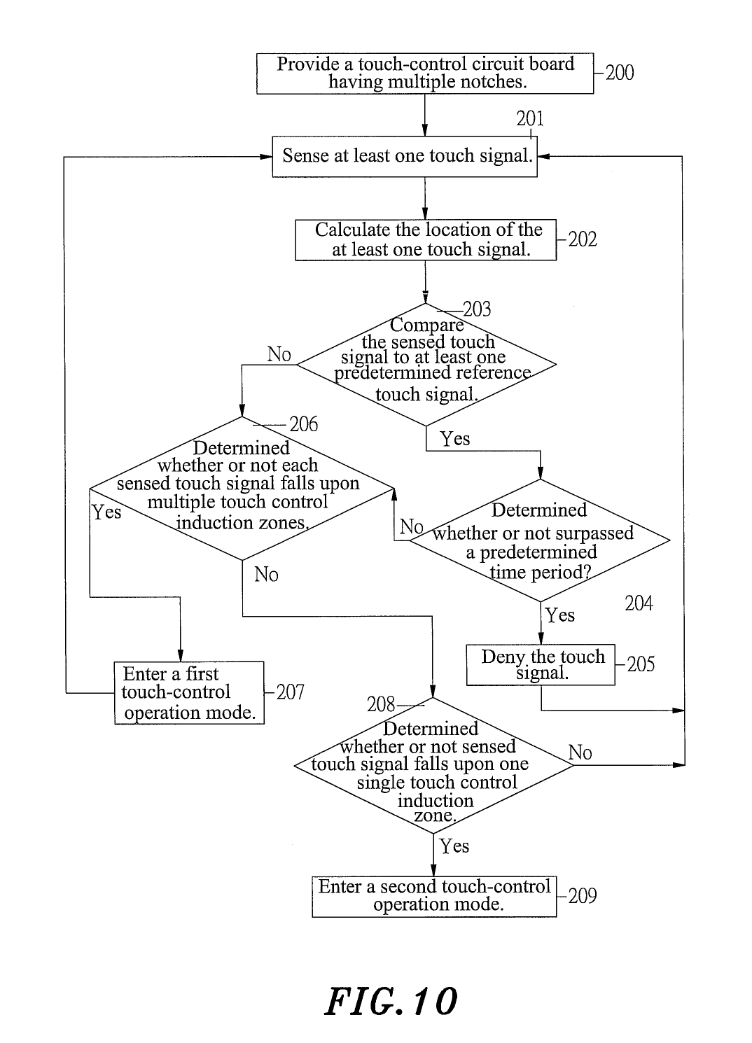

Referring to FIG. 10, as an alternate form of the present invention, the touch control runs subject to the following steps:
(200) Provide the touch-control circuit board 11 having multiple notches for enabling the touch-control circuit board 11 to provide multiple touch control induction zones, wherein the multiple notches include two main notches that are deepest.
(201) Sense at least one touch signal.
(202) Calculate the location of the at least one touch signal.
(203) Compare the sensed touch signal to at least one predetermined reference touch signal, and then proceed to step (204) when matched, or step (206) when not matched.
(204) Determined whether or not surpassed a predetermined time period. And then proceed to step (205) when positive, or step (206) when negative.
(205) Deny the touch signal and then return to step (201).
(206) Determine whether or not each sensed touch signal falls upon multiple touch control induction zones, and then proceed to step (207) when positive, or step (208) when negative.
(207) Enter a first touch-control operation mode and return to step (201).
(208) Determine whether or not each sensed touch signal falls upon one single touch control induction zone, and then return to step (201) when positive, or proceed to step (209) when negative.
(209) Enter a second touch-control operation mode.

According to this alternate form, the touch mouse 1 also executes the early described operation flow. When the user's finger touched the operation area of the surface of the housing 10 of the touch mouse 1 corresponding to the location of the touch-control circuit board 11, according to either of the aforesaid two operation flows, the touch sensor unit 122 of the control module 12 senses the location of the user's finger and the touch control induction zone touched by the user's finger by means of the touch signal(s) induced the touch-control circuit board 11. According to this alternate form, the control unit 121 of the control module 12 will store each received touch signal. Thus, the control unit 121 can run a comparison procedure to determine whether or not the currently received touch signal matches with one of the previously stored touch signals. If the currently received touch signal matches with one previously stored touch signal, the control unit 121 will then determine whether or not the touch signal has been received over a predetermined number of times or time interval. If positive, the control unit 121 will deny the touch signal and judge the location of the user's finger at the touch mouse 1 to be beyond the operation area of the surface of the housing 10 of the touch mouse 1, and then the touch mouse 1 is kept in the standby mode without executing any signal transmission to control the operation of the computer 2. Thus, when a user touches the surface of the housing 10 of the touch mouse 1, the touch mouse 1 automatically determines to enter operation, or to keep in the standby mode. Therefore, the touch mouse 1 is a human-friendly design.

In conclusion, the touch mouse operation method of the present invention has the following advantages and features:
1. The touch mouse 1 comprises a touch-control circuit board 11 having multiple notches for enabling the touch-control circuit board 11 to provide multiple touch control induction zones for quick touch control operation, wherein the multiple notches include two main notches 110 and at least one sub-notch 1110, and the cutting depth of the main notches 110 is deeper than the at least one sub-notch 1110.
2. The touch-control circuit board 11 of the touch mouse 1 comprises two main notches 110 and at least one sub-notch 1110 evenly located on the periphery, and is smoothly bonded to the inner surface of the housing 10 of the touch mouse 1 without causing any air pockets or bubbles. Thus, the thickness of the touch-control circuit board 11 does not affect the successness of the bonding installation of the touch-control circuit board 11 or its conductivity.
3. The touch-control circuit board 11 of the touch mouse 1 comprises multiple touch control induction zones that do not interfere with one another so that a user can selectively touch the touch control induction zones to produce different control signals for different controls.
4. The touch mouse 1 further comprises a control module 12 that determines each received touch signal to be in match with one of pre-stored touch signals. When matched, the control module 12 will then determine whether or not the touch signal has been received over a predetermined number of times or a predetermined time interval. If positive, the control module 12 will deny the touch signal. Thus, when a user touches the surface of the housing 10 of the touch mouse 1, the touch mouse 1 automatically determines to enter operation or to keep in the standby mode, avoiding errors.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A touch mouse operation method used in a touch mouse to enabling said touch mouse to be touched by a user to transmit a control signal to a computer for cursor control, the touch mouse operation method comprising the steps of:
(a) providing a touch-control circuit board and bonding said touch-control circuit board to an inner surface of a housing of said touch mouse, said touch-control circuit board comprising two main notches and at least one sub-notch on the periphery thereof for enabling said touch-control circuit board to provide multiple touch control induction zones, the cutting depth of said main notches being deeper than the at least one sub-notch;
(b) sensing at least one touch signal upon touch of the surface of said housing of said touch mouse by a person;
(c) calculating the location of the at least one touch signal;
(d) determining weather or not the location of the sensed touch signal falls upon multiple touch control induction zones, and then proceeding to the following step (e) when positive, or step (f) when negative;
(e) entering a first touch-control operation mode, and then returning to step (b);
(f) determining weather or not the location of the sensed touch signal falls upon one single touch control induction zone, and then proceeding the following step (g) when negative, or returning to step (b) when positive; and
(g) entering a second touch-control operation mode.

2. The touch mouse operation method as claimed in claim 1, wherein said first touch-control operation mode in step (e) is a Y-axis touch-control operation mode.

3. The touch mouse operation method as claimed in claim 1, wherein said second touch-control operation mode in step (g) is an X-axis touch-control operation mode.

4. The touch mouse operation method as claimed in claim 1, wherein the calculation in step (c) is to compare the sensed touch signal to at least one predetermined reference touch signal, and then to further determine whether or not the sensing of the touch signal surpasses a predetermined time period, when matched, and then deny the touch signal when the sensing of the touch signal surpasses a predetermined time period, or to proceed to step (d) when not matched during the comparison procedure.

5. The touch mouse operation method as claimed in claim 1, further comprising a sub-step to determine whether or not the sensed touch signal continuously or intermittently falls upon multiple touch control induction zones after determination of the location of the sensed touch signal to be fallen upon multiple touch control induction zones in step (d), then the method is to proceed to step (e) when the sensed touch signal continuously falls upon multiple touch control induction zones, or to enter a third touch-control operation mode when the sensed touch signal intermittently falls upon multiple touch control induction zones.

6. The touch mouse operation method as claimed in claim 1, wherein the touch-control circuit board provided in step (a) comprises a first circuit board and a second circuit board, and said multiple touch control induction zones are respectively located on said first circuit board and said second circuit board.

7. The touch mouse operation method as claimed in claim 6, wherein each said touch control induction zone provided in step (a) comprises at least one interconnected rhombic configuration circuit line.

8. The touch mouse operation method as claimed in claim 6, wherein each said touch control induction zone provided in step (a) comprises at least one interconnected hopper configuration circuit line.
